(19) United States
(12) Patent Application Publication
(10) Pub. No.: US 2010/0174457 A1
(43) Pub. Date: Jul. 8, 2010

(54) METHOD FOR CONTROLLING AND/OR REGULATING A STARTING OR MANEUVERING PROCESS IN AN AUTOMATIC TRANSMISSION

(75) Inventors: Rainer Petzold, Friedrichshafen (DE); Mario Steinborn, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/663,347

(22) PCT Filed: May 27, 2008
(86) PCT No.: PCT/EP08/56452

§ 371 Date: Dec. 7, 2009

(30) Foreign Application Priority Data
Jun. 16, 2007 (DE) 10 2007 027 770.0

(51) Int. Cl. B60T 7/12; G06F 7/00

(52) U.S. Cl. 701/51

(57) ABSTRACT

A method for controlling and/or regulating a staring or maneuvering process in an automated transmission of a vehicle in which a required starting torque is provided by a starting clutch and a required braking torque is provided by a brake device. The required braking torque, during the starting or maneuvering process, is provided at least in part by at least a transmission brake.

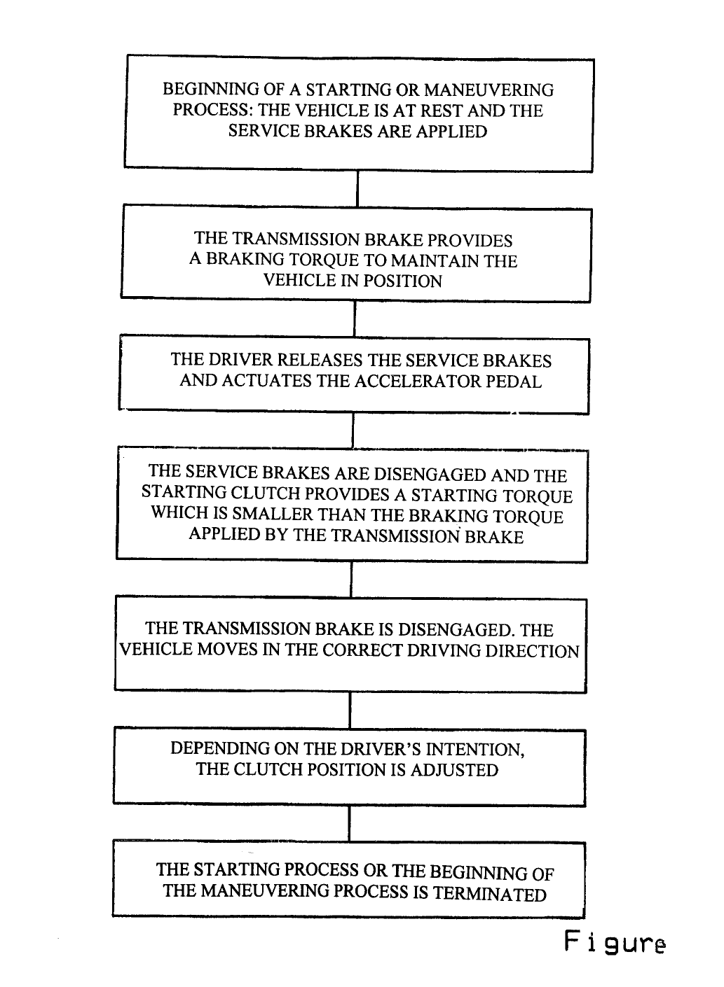

This application is a National Stage completion of PCT/EP2008/056452 filed May 27, 2008, which claims priority from German patent application serial no. 10 2007 027 770.0 filed Jun. 16, 2007.

### FIELD OF THE INVENTION

The present invention concerns a method for controlling and/or regulating a staring or maneuvering process in an automated transmission.

### BACKGROUND OF THE INVENTION

For example, from the DE 101 35 744 A1 document, a device and method are known for avoiding back-rolling of a vehicle. In this known method, a signal is produced by a control device which, when the vehicle is at rest or nearly so, actuates a brake that acts on a transmission of the vehicle in addition to the brakes of the vehicle's braking system. When a forward movement of the vehicle is recognized, the control device reduces the braking pressure in the vehicle's braking system and releases the brake acting on the transmission. This provides additional security in the event that the vehicle's brakes have failed, to avoid unintentional back-rolling of the vehicle. Thus, rolling back of the vehicle is prevented. However, the known method does not enable any control of a starting or maneuvering process.

Besides the staring clutch, the known methods from automotive technology for staring and maneuvering use the service brakes of a vehicle for enabling the maneuvering and starting of the vehicle with an automated transmission. This use of the service brakes, however, results in disadvantageous functional restrictions during the operation of the vehicle.

### SUMMARY OF THE INVENTION

The purpose of the present invention is to propose a method for controlling and/or regulating a starting or maneuvering process of the type described at the beginning, by means of which the functionality of the vehicle is extended during its operation.

Accordingly, a method for controlling and/or regulating a staring or maneuvering process in an automated transmission of a vehicle is proposed in which a required starting torque is provided, by a staring clutch, and a required braking torque is provided, by a braking device, such that during the starting or maneuvering process, the braking torque is provided at least in part by at least one transmission brake.

In this way a transmission brake, usually already present in the automated transmission, can be used to assist the starting or maneuvering process by providing the required braking torque. Thus, in the method according to the invention the use of the service brakes, during a starting or maneuvering process, is not necessary. Consequently, the service brakes can be used in other situations so the functionality is extended.

Preferably, the transmission brake of the automated transmission, typically used for synchronizing claw elements or suchlike, for example during upshifts, can be used. However, it is also possible to provide an additional transmission brake, for example.

The basic idea of the method, according to the invention, is that the vehicle is maintained in position by the transmission brake and the starting clutch provides a torque which is larger than or equal to the starting torque required, but smaller than the torque applied by the transmission brake, so ensuring that the vehicle remains at rest. To start off during the starting or maneuvering process, the braking torque of the transmission brake can then be reduced or the transmission brake can even be completely released.

To optimize the starting process when the braking torque is released. according to a first feature of the present invention, it is provided that the starting torque provided by the starting clutch is determined as a function of the starting resistance of the vehicle. This ensures that a sufficiently large torque, for starting or maneuvering the vehicle, is available. For example, the starting torque can be determined with reference to specific characteristic curves.

Preferably, the braking torque applied by the transmission brake, during the starting or maneuvering process, can be reduced as a function of the driver's wishes in order to move the vehicle in the desired driving direction.

To be able to provide the braking torque required for the method, according to the invention, by means of the transmission brake, in a first further development it can be provided that the transmission brake is arranged on a countershaft or on a transmission input shaft. Other possible configurations are also conceivable for producing the required braking torque. As the transmission brake, for example a clutch or brake device or suchlike that can be coupled with the transmission can be used.

The proposed method for optimized control and/or regulation of a starting or maneuvering process can be implemented by a suitable control device. For example, this control device can be integrated in the transmission control unit of the automated transmission by appropriate logic. Other embodiment variants also are conceivable.

### BRIEF DESCRIPTION OF THE DRAWING

The present invention will be explained in greater detail with reference to a drawing. The single figure illustrating the invention shows an example sequence diagram of an embodiment variant of a method according to the invention.

### DETAILED DESCRIPTION OF THE PREFERRED EMBODIMENTS

Below, an example sequence during starting or maneuvering, in accordance with the method proposed by the invention, is described although overlaps and amplifications are possible and may even be expedient.

To begin with, the vehicle is at rest with a starting or maneuvering gear engaged and with the service brakes of the vehicle actuated. At the beginning of the starting or maneuvering process, a required braking torque is provided by the transmission brake of the vehicle so that the vehicle is maintained in its position.

As soon as the driver is no longer actuating the service brakes but has moved to actuate the accelerator pedal, this intention to start or maneuver is communicated to the system.

Consequently, in accordance with the method of the invention, the service brake is disengaged and the starting clutch can be brought to a position in which a sufficiently large torque for starting or maneuvering is provided. This starting torque can be determined as a function of the starting resistance of the vehicle at the time, for example by the transmission control unit.

However, the transmission brake is applying a sufficient braking torque to maintain the vehicle at rest. Then, depending on the driver's intention, the transmission brake can be disengaged in order to move the vehicle in the correct direction. Depending on the driver's intention, the clutch position can also be adjusted. This terminates the starting process or the beginning of the maneuvering process.

1-7. (canceled)

8. A method for at least one of controlling and regulating one of a staring and maneuvering process of an automated transmission of a vehicle in which a required starting torque is provided by a starting clutch and a required braking torque is provided by a brake device,
wherein the braking torque, during one of the starting and the maneuvering process, is at least partially provided by at least one transmission brake.

9. The method according to claim 8, further comprising the step of, when the brakes of the vehicle have been released and when one of the starting and the maneuvering process is initiated, completely providing the required braking torque by the transmission brake.

10. The method according to claim 9, further comprising the step of recognizing an intention to one of start off and maneuver by actuation of an accelerator pedal of the vehicle, and providing the required starting torque, via the starting clutch, selected to be at least slightly smaller than the braking torque applied.

11. The method according to claim 10, further comprising the step of, when the vehicle is at rest, selecting the braking torque provided by the transmission brake so as to be greater than the starting torque provided by the starting clutch.

12. The method according to claim 11, further comprising the step of determining the starting torque as a function of the starting resistance of the vehicle.

13. The method according to claim 10, further comprising the step of, during one of the starting and the maneuvering process, reducing the braking torque of the transmission brake as a function of the driver's intention in order to move the vehicle in the desired driving direction.

14. The method according to claim 13, further comprising the step of arranging the transmission brake on one of a countershaft and on a transmission input shaft.
